(19) United States
(12) Patent Application Publication
(10) Pub. No.: US 2023/0083603 A1
(43) Pub. Date: Mar. 16, 2023

(54) FLOORING UNDERLAYMENT MATERIAL, AND RELATED METHODS AND SYSTEMS

(71) Applicants: Vipin Kumar, Seattle, WA (US); Krishna Nadella, Redmond, WA (US)

(72) Inventors: Vipin Kumar, Seattle, WA (US); Krishna Nadella, Redmond, WA (US)

(21) Appl. No.: 17/930,998

(22) Filed: Sep. 9, 2022

Related U.S. Application Data
(60) Provisional application No. 63/242,596, filed on Sep. 10, 2021.

(51) Int. Cl. C08J 9/12

(52) U.S. Cl. CPC C08J 9/122; C08J 2367/02; C08J 2205/052; C08J 2203/06

(57) ABSTRACT

A material for making an underlayment of a floor includes a thermoplastic polymer that has a thickness and a microstructure. The microstructure includes a plurality of closed cells, each cell containing a void and each cell having a maximum dimension extending across the void within the cell that is less than or equal to 200 micrometers long. The microstructure also includes a density that is greater than or equal to 0.18 grams per cubic centimeter.

### CROSS REFERENCE TO RELATED APPLICATION AND CLAIM OF PRIORITY

This application claims priority from commonly owned U.S. Provisional Patent Application 63/242,596 filed 10 Sep. 2021, and titled “A Foam Underlayment For Flooring”, presently pending, which is incorporated by this reference.

### BACKGROUND

Floor coverings generally require an underlayment that is installed between the floor covering, which is the finished topmost flooring layer, and the subfloor, which is the unfinished base that structurally supports the floor covering and the underlayment that lie on top of it. The underlayment may be attached to the subfloor with adhesives, staples, nails, and suchlike, or it may rest unaffixed to the subfloor. In the latter case, the underlayment is used in floating floor systems and applications whereby both the floor covering and underlayment lie on top of the subfloor without being secured to the subfloor such that they are said to “float” detachedly above the subfloor. These types of flooring systems are very flexible since they are easier to install and uninstall; are more convenient to repair, including local spot repairs, and at a lower cost; and can be relocated to some other part of the house or building.

The underlayment is essential to a quality floor covering and often serves multiple functions. The underlayment layer may smooth out the irregular surfaces of the unfinished subfloor to ensure that the floor covering at the top remains uniformly even and smooth. The underlayment can cushion the floor covering by imparting a certain amount of resiliency and pliability that lessen the floor's impact on a person's knees and joints. In general, the thicker the underlayment, the more resiliency or cushioning it provides. The underlayment may also function as an insulating material that provides a barrier to heat entering and leaving through a floor, to noise, to moisture, and even to liquid.

Unfortunately, though, many current underlayment layers often interfere with the subfloor's support of the floor covering and do not themselves replace that support to the floor covering. As a result, the condition of floor covering often worsens when the floor covering is subjected to excessive or continuous loads or pressures. For example, LVT (luxury vinyl tile) floor coverings tend to be weakest at the joints where the tiles interlock with each other. With a thick underlayment layer (i.e., greater than 1.5 mm) and a compressive load or pressure applied to the floor covering, the cushioning effect of the thick underlayment creates uneven stress across the floor tiles, thereby making the weaker points of the tiles at the joints more susceptible to bending, breaking, and deteriorating. Although a thinner underlayment layer may better support the LVT against uneven stress across the floor tiles because it is less pliable or resilient, the thinner underlayment layer is also less effective at preventing or even reducing the transmission of noise, moisture, or liquid through the floor.

Thus, there is a need for an underlayment that provides pliability or resiliency; that serves as a barrier to noise, moisture, and liquid; and that does not compromise the subfloor's support of the floor covering.

### SUMMARY

In an aspect of the invention, a material for making an underlayment of a floor includes a thermoplastic polymer that has a thickness and a microstructure. The microstructure includes a plurality of closed cells, each cell containing a void and each cell having a maximum dimension extending across the void within the cell that is less than or equal to 200 micrometers long. The microstructure also includes a density that is greater than or equal to 0.18 grams per cubic centimeter.

With a microstructure that has very small closed cells, or bubbles, and a density greater than or equal to 0.18 grams per cubic centimeter, a compressive strength of the thermoplastic material may be generated that does not interfere with the sub-floor's support of the floor covering, i.e., that effectively or more evenly transfers the loading experienced by the floor covering to the sub-floor. In addition, the closed cells, or bubbles, of the microstructure provide an effective barrier against noise, moisture, and liquid travelling through the floor, and thus help keep noise generated above the floor from being heard below the floor and vice-versa, as well as mitigate damage to the sub-floor or other portions of the structure that moisture and liquid may cause.

In another aspect of the invention, a method for making a floor underlayment material includes: 1) infusing a thermoplastic material with a gas; 2) heating the gas-infused thermoplastic material to a temperature that is at least the glass-transition-temperature of the gas-infused thermoplastic material, to nucleate closed cells in the gas-infused thermoplastic material, wherein each closed cell has a void and a maximum dimension extending across the void; 3) maintaining the temperature to allow the closed cells to grow in size such that the maximum dimension of the void of each of the closed cells is less than or equal to 200 micrometers; and 4) cooling the gas-infused thermoplastic material to stop the growth of the closed cells such that the density of the material is equal to or greater than 0.18 grams per cubic centimeter.

### BRIEF DESCRIPTION OF THE FIGURES

FIG. 1 is a cross-sectional view of a floor, according to an embodiment of the invention.

FIG. 2 is a cross-sectional view of the underlayment of the floor shown in FIG. 1 that shows the microstructure of the underlayment's material, according to an embodiment of the invention.

FIG. 3 is a schematic view of a process for making material that the underlayment shown in FIGS. 1 and 2 includes, according to another embodiment of the invention.

Each of FIGS. 4A-4C is a graph that shows compressive stress data for two, different underlayments for a floor, each according to an embodiment of the invention.

FIG. 5 is a cross-sectional view of another underlayment for a floor that shows the microstructure of the underlayment's material, according to another embodiment of the invention.

### DETAILED DESCRIPTION

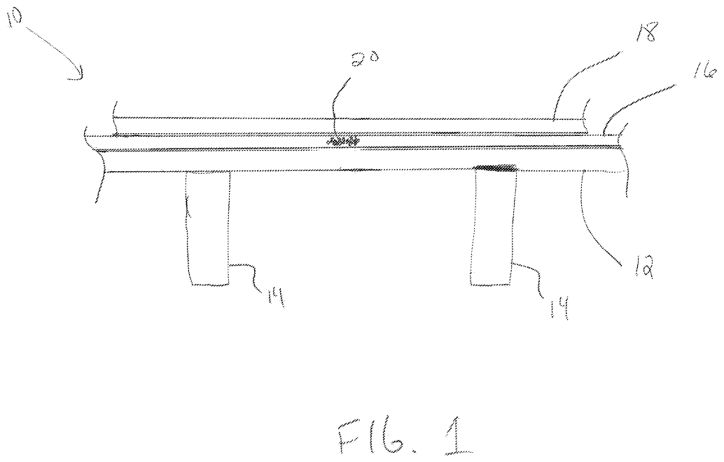

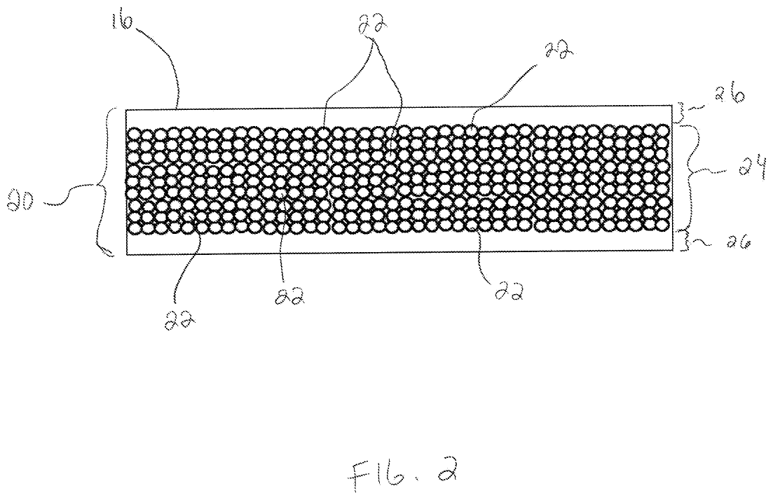

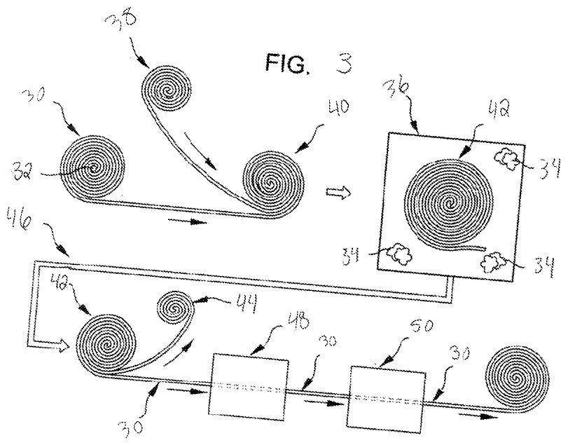

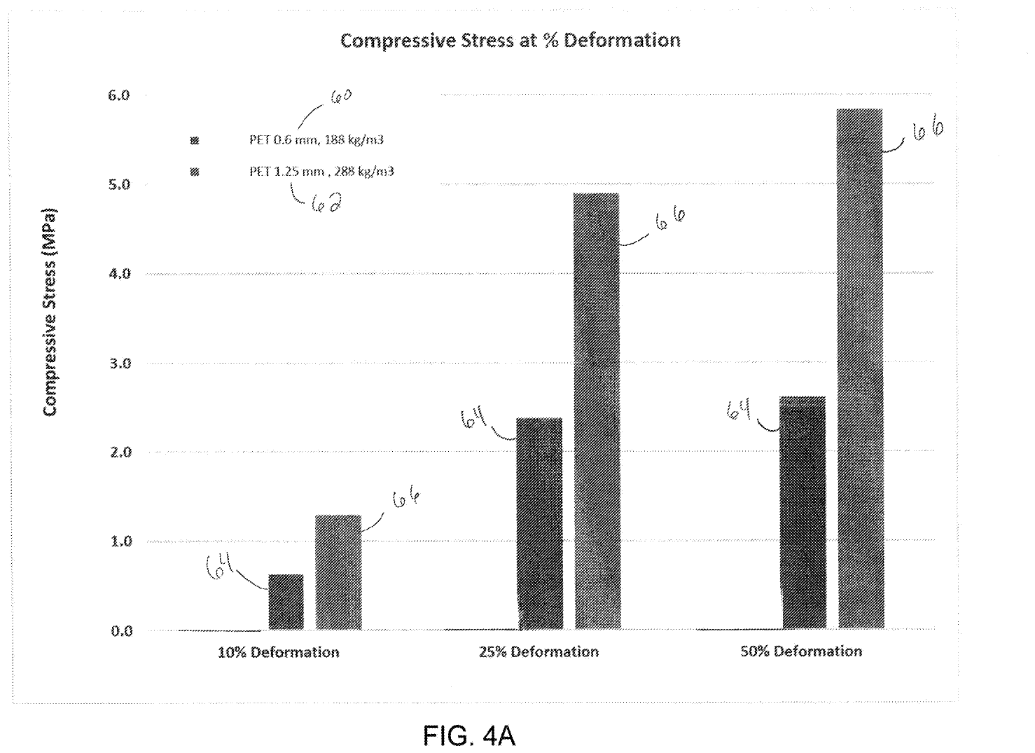

FIG. 1 is a cross-sectional view of a floor 10, according to an embodiment of the invention. The floor 10 includes a sub-floor 12 that is mounted to a plurality of floor joists 14 (only two shown), an underlayment 16, and a floor covering 18. Here the floor covering 18 is a luxury vinyl tile (LVT), but in other floor systems the floor covering 18 may be linoleum, or any other desired floor covering such as laminate, hardwood, carpet, porcelain, and/or stone. The underlayment 16 (discussed in greater detail in conjunction with FIG. 2) includes a thermoplastic polymer that has a microstructure 20 (only a portion shown in FIG. 1 for clarity) that extends the length of the underlayment 16 in the directions along the length of the joists 14 and along the length between the joists 14 (see FIG. 2). The microstructure 20 includes a plurality of closed cells, each cell containing a void and each cell having a maximum dimension extending across the void within the cell that is less than or equal to 200 micrometers (μm) long. The microstructure 20 also has a density that is greater than or equal to 0.18 grams per cubic centimeter.

With a microstructure 20 that has very small closed cells, or bubbles, and a density greater than or equal to 0.18 grams per cubic centimeter, a compressive strength of the thermoplastic material may be generated that does not interfere with the support that the sub-floor 12 provides the floor covering 18, i.e., that effectively or more evenly transfers the loading experienced by the floor covering 18 to the sub-floor 12. In addition, the closed cells, or bubbles, of the microstructure 20 provide an effective barrier against noise, moisture, and liquid travelling through the floor 10, and thus help keep noise generated above the floor 10 from being heard below the floor 10 and vice-versa, as well as mitigate damage to the sub-floor 12 or other portions of the structure that moisture and liquid may cause.

The underlayment 16 may have any desired thickness and may be mounted to the sub-floor 12 in any desired manner. For example, in this and other embodiments, the thickness of the underlayment ranges between 0.5 millimeters (mm) and 2.0 mm; and the underlayment “floats” on top of the sub-floor 12, that is, the underlayment 16 is not fastened to the sub-floor 12, but rather is simply placed on top of the sub-floor 12. Adjacent sheets of underlayment 16, and the walls and/or thresholds (not shown) that define the boundary of the floor 10, hold the underlayment 16 in the desired position over the sub-floor 12. Likewise, the floor covering 18 may be mounted to the underlayment 16 in any desired manner. Here again, in this and other embodiments the floor covering 18 “floats” on top of the underlayment 16. In other embodiments, the underlayment 16 may be mounted to the sub-floor 12 and/or the floor covering 18 may be mounted to the underlayment 16 with any conventional adhesive and/or nails, staples, or screws.

Still referring to FIG. 1, the thermoplastic polymer included in the underlayment 16 may be any desired thermoplastic polymer that provides the mechanical properties, such as compression strength, desired. For example, the thermoplastic polymer may be any amorphous or semi-crystalline thermoplastic. In this and other embodiments, the thermoplastic polymer included in the underlayment 16 is polyethylene terephthalate (PET). In other embodiments, the thermoplastic polymer included in the underlayment 16 includes one or more of the following polymers: polyolefins such as polypropylene (PP) and polyethylene (PE), thermoplastic polyurethane (TPU), thermoplastic elastomer (TPE), polystyrene, polycarbonate, acrylonitrile-butadiene-styrene, glycol modified PET, polyethylene, polypropylene, NORYL (a blend of polyphenylene oxide and polystyrene), and polyvinyl chloride. The underlayment 16 may also be fabricated from recycled polymer materials, including recycled polyethylene terephthalate and mixed recycled plastics.

FIG. 2 is a cross-sectional view of the underlayment 16 shown in FIG. 1 that shows the microstructure 20 of the underlayment's thermoplastic polymer, according to an embodiment of the invention. The microstructure 20 of the underlayment's thermoplastic polymer includes many closed cells 22 (only 6 labeled in FIG. 2 for clarity)—about 10⁸ or more per cubic centimeter (cm³)—with each closed cell containing a void. The size of each closed cell 22 is less than or equal to 200 μm long at its maximum dimension that extends across the void. Because the geometry of each closed-cell is rarely, if at all, a perfect sphere, the size of each closed cell is arbitrarily identified as the length of the longest chord that extends through the void within the closed cell. For example, the size of an oblong cell would be the length of the longest chord that extends in the same direction as the cell's elongation, and the size of a sphere would be the length of the sphere's diameter.

In this and other embodiments, the many closed cells 22 included in the microstructure 20 are uniformly dispersed throughout the thickness of a layer 24 which forms a portion of the thickness of the underlayment 16. And, the size of each of the closed cells 22 included in the layer 24 ranges between 5 and 50 μm long at its maximum dimension that extends across the void. In other embodiments, the size of each of the closed cells 22 in the microstructure 20 may be smaller than 5 μm long at its maximum dimension that extends across the void; or each may be larger than 50 μm long at its maximum dimension that extends across the void.

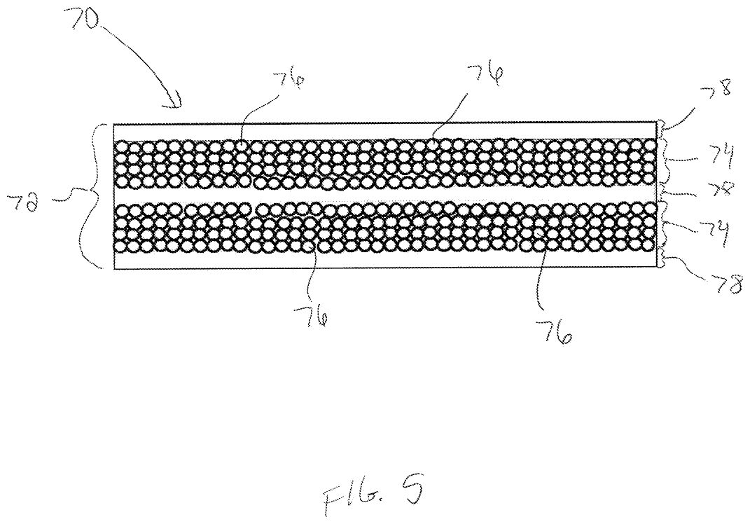

More, other embodiments are also possible. For example, the closed cells 22 may not be uniformly dispersed throughout the thickness of the layer 24. For another example, the microstructure 20 may include more than one layer 24 of closed cells 22, with the closed cells 22 of each of the layers 24 having the same size (see FIG. 5), or with each layer 24 having closed cells 22 having a size that is different than the closed cells 22 of each of the other layers 24.

The microstructure 20 may also include a region or layer that does not include any closed cells 22. For example, in this and other embodiments the microstructure 20 also includes two layers 26 that do not have any cells (open or closed), and that are located above and below the layer 24. Each layer 26 has a thickness that is equal to the thickness of the other layer 26, and is much less than the thickness of the layer 24, which effectively makes the layers 26 a solid skin of the underlayment 16. Because these two layers 26 do not include any cells, they provide a barrier against moisture and liquid in addition to the barrier that the layer 24 of closed cells 22 provides against moisture and liquid, especially when the underlayment “floats” in the floor 10 (FIG. 1). Here, the layers 26 are integral to the layer 24—i.e., not a separate layer that is laminated to the layer 24, or co-extruded with the layer 24—which helps prevent delamination of the layers 26 from the layer 24 during transportation, installation, and use.

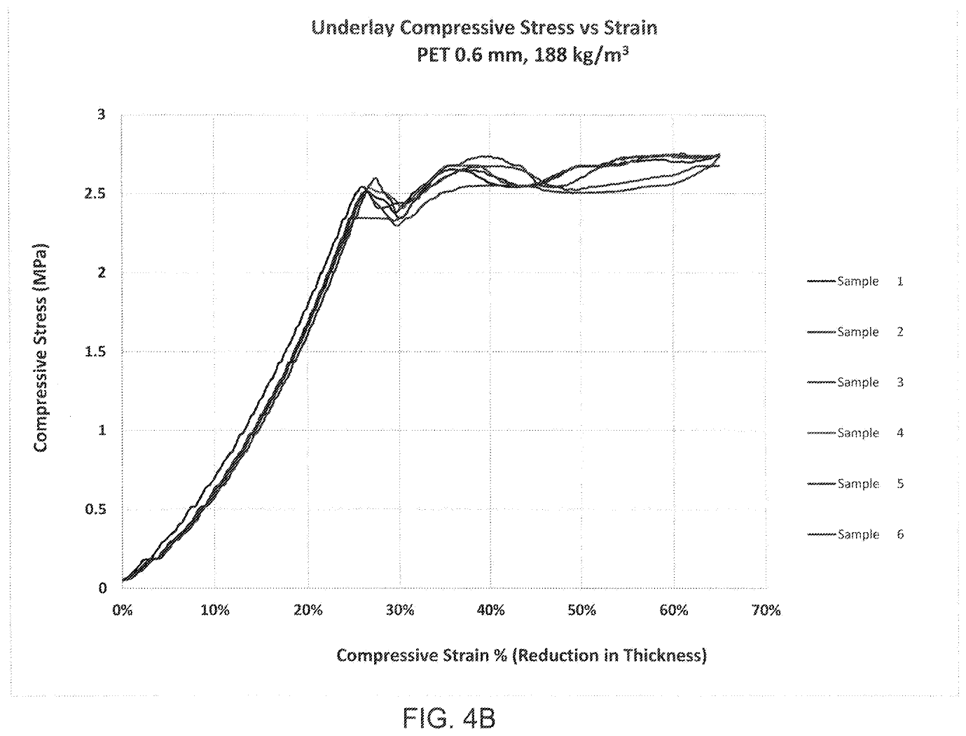

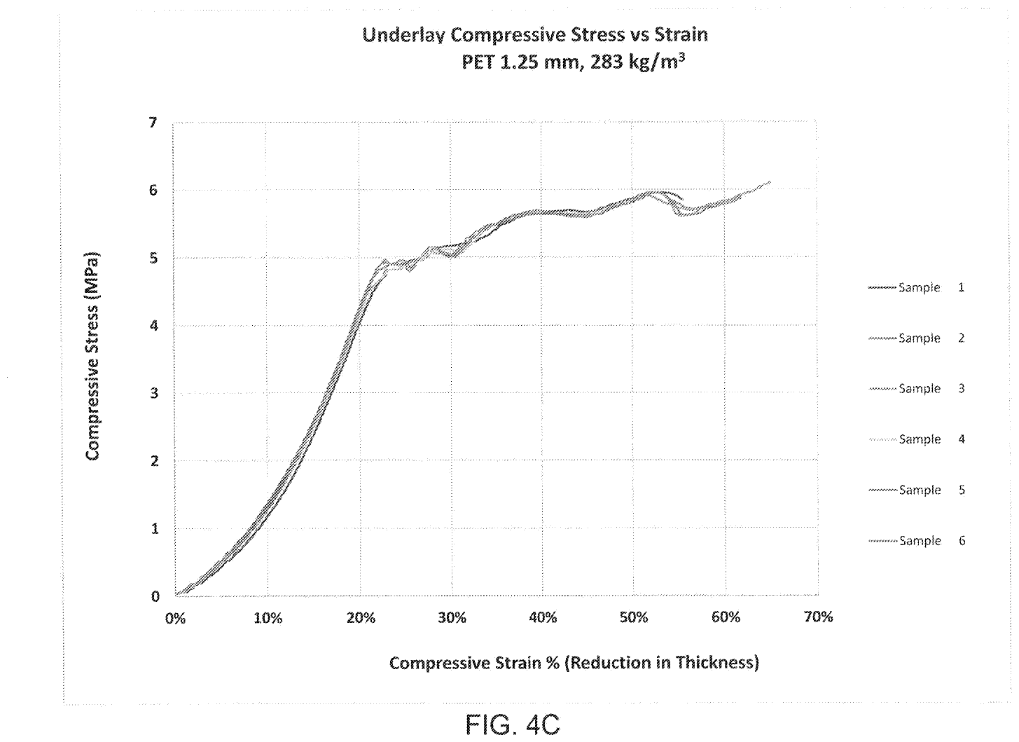

FIG. 3 is a schematic view of a process for generating the microstructure 20 (FIG. 2) that the underlayment 16 includes, according to an embodiment of the invention. The microstructure 20 may be generated by any desired process that provides the thermoplastic polymer the desired size of the closed cells 22 with the desired density (apparent density of the underlayment 16). For example, in this and other embodiments the microstructure 20 is generated by a solid-state microcellular foaming process. More specifically, the process for generating the microstructure 20 in the thermoplastic polymer 30 includes dissolving into the polymer 30 (here shown as a film rolled around a drum 32, but may be a block or thin sheet) a gas 34 that does not react with the polymer 30. The process also includes making the polymer 30 with the dissolved gas thermodynamically unstable at a temperature that is or close to the glass transition temperature of the polymer 30 with the gas 34 dissolved in it—the temperature at which the polymer 30 is easily malleable but has not yet melted. With the temperature at or near the glass transition temperature, bubbles of the gas 34 can nucleate and grow in regions of the polymer 30 that are thermodynamically unstable—i.e., supersaturated. When the bubbles have grown to a desired size, the temperature of the polymer 30 is reduced below the glass transition temperature to stop their growth, and thus provide the polymer 30 with a microstructure 20 having bubbles, i.e., closed-cells 22, whose size may be less than or equal to 200 μm long.

In the process, the first step 36 is to dissolve into the polymer 30 any desired gas 34 that does not react with the polymer 30. For example, in this and certain other embodiments of the process, the gas 34 may be carbon dioxide (CO₂) because CO₂ is abundant, inexpensive, and does not react with PET. In other embodiments of the process, the gas may be nitrogen and/or helium. Dissolving the gas 34 into the polymer 30 may be accomplished by exposing the polymer 30 for a period of time to an atmosphere of the gas 34 having a temperature and a pressure. The temperature, pressure, and period of time may be any desired temperature, pressure, and period of time to dissolve the desired amount of gas 34 into the polymer 30. The amount of gas 34 dissolved into the polymer 30 is directly proportional to the pressure of the gas 34 and the period of time that the polymer 30 is exposed to the gas 34 at a specific temperature and specific pressure, but is inversely proportional to the temperature of gas 34. For example, in this and certain other embodiments, the temperature may be 72° Fahrenheit, the pressure may be 800 pounds per square inch (psi), and the duration of the period may be 10 hours. This typically saturates the polymer 30 with the gas 34. In other embodiments, the pressure may range between 500 psi and 1000 psi, and the duration of the period may range between 4 hours and 24 hours.

Because the layers of the rolled polymer film 30 that lie between adjacent layers or between a layer and the drum 32 are substantially unexposed to the atmosphere when the roll is placed in the atmosphere, a material 38 is interleaved between each layer of the rolled polymer film 30, before gas 34 is dissolved into the polymer 30 at step 36. This allows each layer of the rolled polymer film 30 to be exposed to the atmosphere of gas 34. In this and certain other embodiments, the material 38 includes a sheet of cellulose, and is disposed between each layer of the polymer film 30 by merging the sheet with the film and then rolling the combination into a single roll 40. The material 38 exposes each layer of the polymer film 30 by allowing the gas 34 to easily pass through it. After the gas 34 has saturated the polymer film 30, the material 38 may be removed from the roll 42 and saved as a roll 44 for re-use.

The next step 46 in the process includes exposing the polymer film 30 with the dissolved gas 34 to an atmosphere having less pressure than the one in the first step 36 to cause the combination of the polymer film 30 and the gas 34 dissolved in the polymer film 30 to become thermodynamically unstable—i.e., the whole polymer or regions of the polymer to become supersaturated with the dissolved gas 34. For example, in this and certain other embodiments, the reduction in pressure may be accomplished by simply exposing the polymer film 30 to atmospheric pressure, which is about 14.7 psi, in the ambient environment.

When the combination of the polymer film 30 and the dissolved gas 34 becomes thermodynamically unstable, the dissolved gas tries to migrate out of the film 30 and into the ambient environment surrounding the film 30. Because the dissolved gas 34 in the interior regions of the polymer film 30 must migrate through the regions of the polymer film 30 that are closer to the film's surface to escape from the polymer film 30, the dissolved gas in the interior regions begins to migrate after the dissolved gas 34 in the surface regions begins to migrate, and takes more time to reach the ambient environment surrounding the polymer film 30 than the dissolved gas 34 in the film's regions that is closer to the film's surface. Thus, before heating the polymer film 30 to a temperature that is or is close to its glass transition temperature, one can modify the concentration of dissolved gas 34 in regions of the polymer film 30 by exposing the polymer film 30 to an atmosphere having less pressure than the one in the first step 36 for a period of time. Because the concentration of dissolved gas 34 depends on the amount of gas that escapes into the ambient environment surrounding the polymer film 30, the concentration of dissolved gas 34 is inversely proportional to the period of time that the film 30 is exposed to the low-pressure atmosphere before being heated to its or close to its glass transition temperature.

In this manner, an integral skin, such as the layer 26 of the microstructure 20 (FIG. 2), may be formed in the polymer film 30 when the film 30 is heated to a temperature that is or is close to its glass transition temperature. For example, in this and certain other embodiments, the roll 42 of polymer film 30 and interleaved material 38 can remain in a thermodynamically unstable state for a period of time before removing the material 38 from the roll 42 and heating the polymer film 30. This allows some of the gas dissolved in the region of the film 30 adjacent the film's surface to escape. With the gas absent from this region of the film 30, this region becomes more thermodynamically stable than the regions that are further away from the film's surface. With a sufficient amount of thermodynamic stability in the region, bubbles or closed cells 22 won't nucleate in the region when the film 30 is heated close to its glass transition temperature. Consequently, closed cells 22 (FIG. 2) can be omitted from this region of the polymer film 30, leaving a solid portion of the microstructure 20 that is integral to the closed cell portion 24 of the microstructure 20, such as the skin or layer 26 of the microstructure 20 (FIG. 2). Because the thickness of the layer 26 depends on the absence of dissolved gas 34 in the region of the film 30, the thickness of the layer 26 or solid skin portion is directly proportional to the period of time that the film 30 spends in a thermodynamically unstable state before being heated to or substantially close to its glass transition temperature. In this and certain other embodiments, the thickness of the integral skin ranges between 5-200 μm.

The next step 48 in the process is to nucleate and grow bubbles in the polymer 30 to form closed cells 22 (FIG. 2) and achieve a desired apparent density for the polymer film 30. Bubble nucleation and growth begin about when the temperature of the polymer film 30 is or is close to the glass transition temperature of the polymer film 30 with the dissolved gas 34. The duration and temperature at which bubbles 22 are nucleated and grown in the polymer 30 may be any desired duration and temperature that provides the desired apparent density. For example, in this and certain other embodiments, the temperature that the PET polymer 30 is heated to is approximately 190°-280° Fahrenheit, which is about 30°-120° Fahrenheit warmer than the glass transition temperature of the polymer without any dissolved gas 34. The PET film 30 is held at approximately 190°-280° Fahrenheit for approximately 30 seconds. This provides an apparent density of the thermoplastic polymer with the closed-cell microstructure of about 0.31 grams per cubic centimeter. If the PET film 30 is held at 190°-280° Fahrenheit for a period longer than 30 seconds, such as 120 seconds, then the bubbles grow larger, and thus the size of resulting closed cells 22 are larger. This may provide an apparent density of the closed-cell microstructure of about 0.138-0.26 grams per cubic centimeter. If the PET film 30 is held at 190°-280° Fahrenheit for a period shorter than 30 seconds, such as 10 seconds, then the bubbles remain small, and thus the size of resulting closed cells 22 are smaller. This may provide a relative density of the closed-cell microstructure of about 0.552 grams per cubic centimeter.

To heat the polymer film 30 that includes the dissolved gas 34, one may use any desired heating apparatus. For example, in this and certain other embodiments, the PET film 30 may be heated by a roll fed flotation/impingement oven, such as the oven disclosed in U.S. patent application Ser. No. 12/423,790, titled ROLL FED FLOTATION/IMPINGEMENT AIR OVENS AND RELATED THERMOFORMING SYSTEMS FOR CORRUGATION-FREE HEATING AND EXPANDING OF GAS IMPREGNATED THERMOPLASTIC WEBS, filed 14 Apr. 2009. This oven suspends and heats a polymer film that moves through the oven, without restricting the expansion of the film.

The next step 50 in the process includes reducing the temperature of the heated polymer 30, and thus the malleability of the polymer 30 that occurs at or near the glass transition temperature, to stop the growth of the bubbles and establish the closed cells 22. The temperature of the heated polymer 30 may be reduced using any desired technique. For example, in this and certain other embodiments, the polymer film 30 may be left to cool at ambient room temperature—i.e., simply removed from the heating apparatus. In other embodiments, the heated polymer film 30 may be quenched by drenching it with cold water, cold air, or any other desired medium.

Other embodiments of the process are possible. For example, the polymer film 30 can be heated to a temperature that is or close to its glass transition temperature when the polymer film 30 is initially exposed to an atmosphere that causes the gas dissolved in the polymer film 30 to become thermodynamically unstable. This allows one to make a film that does not include a solid skin layer 26 or includes a solid skin layer 26 having a minimal thickness.

By modifying and controlling the parameters of the process for generating the microstructure of the underlayment's thermoplastic polymer, one can generate a variety of different microstructures 20 in the underlayment's thermoplastic polymer, which allows one to form an underlayment 16 that has a variety of desired characteristics. For example, one can generate a microstructure 20 that includes closed cells that are around 5 μm in size, and has an apparent density that is 0.18 grams per cubic centimeter. Or, one can generate a microstructure 20 that includes closed cells that are around 5 μm in size, and has an apparent density that is 0.3 grams per cubic centimeter. Likewise, one can generate a microstructure 20 that includes closed cells that are around 200 μm in size, and has an apparent density that is 0.18 grams per cubic centimeter. Or, one can generate a microstructure 20 that includes closed cells that are around 200 μm in size, and has an apparent density that is 0.3 grams per cubic centimeter.

Each of FIGS. 4A-4C is a graph that shows compressive stress data for two, different underlayments 60 and 62 for a floor, each according to an embodiment of the invention. FIG. 4A shows compressive stress data of each of the two underlayments 60 and 62 for easy comparison. The data labeled 64 corresponds to the compressive stress and compressive strain experienced by the underlayment 60. The data labeled 66 corresponds to the compressive stress and compressive strain experienced by the underlayment 62. FIG. 4B shows the compressive stress strain curve of the underlayment 60. And FIG. 4C shows the compressive stress strain curve of the underlayment 62.

In this and certain other embodiments, the underlayment 60 is 0.6 mm thick, and includes a PET thermoplastic polymer whose microstructure 20 (FIG. 2) includes closed cells 22 (FIG. 2) whose size is less than 200 μm, and has a density of 0.18 grams per cubic centimeter. And, the underlayment 62 is 1.25 mm thick, and includes a PET thermoplastic polymer whose microstructure 20 (FIG. 2) includes closed cells 22 (FIG. 2) whose size is less than 200 μm, and has a density of 0.28 grams per cubic centimeter. As can be seen in FIGS. 4A-4C, the thicker and more dense underlayment 62 can experience a compressive stress of 1.3 megapascals (MPa) or 5,928 Newtons (N) before its thickness is reduced 10% or to 1.13 mm; while the thinner and less dense underlayment 60 can experience a compressive stress of 0.62 megapascals (MPa) or 283 Newtons (N) before its thickness is reduced 10% or to 0.54 mm. Similarly, FIG. 4B shows the response of the underlayment 60 to a variety of different compressive stresses ranging from 0.0 MPa to 2.75 MPa; and FIG. 4C shows the response of the underlayment 62 to a variety of different compressive stresses ranging from 0.0 MPa to 6.1 MPa.

FIG. 5 is a cross-sectional view of another underlayment 70 for a floor that shows a microstructure 72 of the underlayment's thermoplastic polymer, according to another embodiment of the invention. The microstructure 72 is similar to the microstructure 20 (FIG. 2) of the underlayment 16 (FIG. 2), except that the microstructure 72 includes two regions or layers 74 having closed cells 76 (only four labeled for clarity), and three regions or layers 78 that does not include any closed cells 76. In this and other embodiments, the underlayment 70 may be formed by fusing or otherwise attaching two underlayments 16 together to form an underlayment 70 that is thicker than each of the underlayments 16. In this manner, One can easily obtain an underlayment 70 whose thickness is greater than 1.5 mm, such as 6 mm or more.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A material for making an underlayment of a floor, the material comprising:
a thermoplastic polymer having:
a thickness,
a microstructure that includes a plurality of closed cells, each cell containing a void and each cell having a maximum dimension extending across the void within the cell that is less than or equal to 200 micrometers long, and
a density that is greater than or equal to 0.18 grams per cubic centimeter.

2. The material of claim 1 wherein the thermoplastic material includes polyethylene terephthalate (PET).

3. The material of claim 1 wherein the microstructure is formed by a solid-state microcellular foaming process.

4. The material of claim 1 wherein the maximum dimension of the void of each of the closed cells is greater than or equal to 5 micrometers.

5. The material of claim 1 wherein the maximum dimension of the void of each of the closed cells ranges between 5 micrometers and 50 micrometers.

6. The material of claim 1 wherein the density is less than or equal to 0.3 grams per cubic centimeter.

7. The material of claim 1 wherein the thickness of the thermoplastic polymer ranges between 0.5 millimeters and 6.0 millimeters.

8. The material of claim 1 wherein the thickness of the thermoplastic polymer ranges between 1 millimeter and 2 millimeters.

9. The material of claim 1 wherein the amount of stress in compression that reduces by 10% the thickness of the thermoplastic polymer relative to the polymer's thickness when not stressed in compression, ranges between 0.16 MPa and 2.5 MPa.

10. The material of claim 1 wherein the amount of stress in compression that reduces by 25% the thickness of the thermoplastic polymer relative to the polymer's thickness when not stressed in compression, ranges between 2.3 MPa and 4.9 MPa.

11. The material of claim 1 wherein the amount of stress in compression that reduces by 25% to 35% the thickness of the thermoplastic polymer relative to the polymer's thickness when not stressed in compression, ranges between 0.65 MPa and 4.9 MPa.

12. The material of claim 1 wherein the amount of stress in compression that reduces by 50% the thickness of the thermoplastic polymer relative to the polymer's thickness when not stressed in compression, ranges between 0.7 MPa and 5.9 MPa.

13. The material of claim 1 wherein:
the density of the thermoplastic polymer is 0.18 grams per cubic centimeter,
the thickness of the thermoplastic polymer is 0.6 millimeters, and
the amount of stress in compression that reduces by 10% the thickness of the thermoplastic polymer relative to the polymer's thickness when not stressed in compression, is 0.62 MPa.

14. The material of claim 1 wherein:
the density of the thermoplastic polymer is 0.28 grams per cubic centimeter,
the thickness of the thermoplastic polymer is 1.25 millimeters, and
the amount of stress in compression that reduces by 10% the thickness of the thermoplastic polymer relative to the polymer's thickness when not stressed in compression, is 1.3 MPa.

15. The material of claim 1 wherein the microstructure of the thermoplastic polymer includes a layer that does not include closed cells.

16. A method for making a material for an underlayment of a floor, the method comprising:
infusing a thermoplastic material with a gas;
heating the gas-infused thermoplastic material to a temperature that is at least the glass-transition-temperature of the gas-infused thermoplastic material, to nucleate closed cells in the gas-infused thermoplastic material, wherein each closed cell has a void and a maximum dimension extending across the void;
maintaining the temperature to allow the closed cells to grow in size such that the maximum dimension of the void of each of the closed cells is less than or equal to 200 micrometers; and
cooling the gas-infused thermoplastic material to stop the growth of the closed cells such that the density of the material is equal to or greater than 0.18 grams per cubic centimeter.

17. The method of claim 16 wherein the gas infused into the thermoplastic material includes carbon dioxide (CO₂).

18. The method of claim 16 wherein the temperature that the gas-infused thermoplastic material is heated to ranges between 180°-280° Fahrenheit.

19. The method of claim 16 wherein the temperature is maintained until the void of each of the closed cells has a maximum dimension that is greater than or equal to 5 micrometers.

20. The method of claim 16 wherein the temperature is maintained until the void of each of the closed cells has a maximum dimension that ranges between 5 micrometers and 50 micrometers.

21. The method of claim 16 wherein the temperature is maintained until the density of the thermoplastic material is less than or equal to 0.3 grams per cubic centimeter.

22. The method of claim 16 wherein the temperature is maintained until:
the void of each of the closed cells has a maximum dimension that ranges between 1 micrometer and 100 micrometers,
the density of the thermoplastic material is 0.18 grams per cubic centimeter, and
the thickness of the thermoplastic material is 0.6 millimeters.

23. The method of claim 16 wherein the temperature is maintained until:
the void of each of the closed cells has a maximum dimension that ranges between 1 micrometer and 100 micrometers,
the density of the thermoplastic material is 0.28 grams per cubic centimeter, and
the thickness of the thermoplastic material is 1.5 millimeters.

24. The method of claim 16 further comprising allowing some of the gas infused into the thermoplastic material to migrate out of the material before heating the material to the temperature.
